(19) United States
(12) Patent Application Publication
(10) Pub. No.: US 2012/0003964 A1
(43) Pub. Date: Jan. 5, 2012

(54) Method, System, and Computer Program Product for Providing Customized Information to Mobile Devices

(76) Inventors: Armstrong Soo, Sen Ramon, CA (US); Bernard Ku, Austin, TX (US)

(21) Appl. No.: 12/827,835

(22) Filed: Jun. 30, 2010

(51) Int. Cl. H04M 3/42

(52) U.S. Cl. 455/414.1

(57) ABSTRACT

Customized information is provided to at least one mobile device with respect to at least one provider of products or services. A request from the mobile device is received for customized information regarding a product or service from the at least one provider of products or services. A customized response to the request is generated based on application of a business rule and a current location of the mobile device. The response includes the requested customized information regarding the product or service. The customized response is provided to the mobile device, including information associated with the current location of the mobile device.

### TECHNICAL FIELD

The present disclosure relates generally to telecommunications, and, more particularly, to providing customized information to mobile devices.

### BACKGROUND

Mobile devices are becoming a modern-day necessity, as individuals rely more and more heavily on the applications available on mobile devices. One such application is the Global Positioning System (GPS) application. GPS applications provide valuable information to users, including directions to points of interest. For example, a user of a mobile device may type in the name of a nearby store into a GPS-enabled device, and the GPS application will cause the location of the store to be displayed on a map, along with directions. However, current GPS applications are limited in the variety and amount of detailed information they can provide

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to one embodiment, a method provides customized information to at least one mobile device with respect to at least one provider of products or services. At least one request is received from at least one mobile device for customized information regarding a product or service from the at least one provider of products or services. A customized response to the request is generated based on application of a business rule and a current location of the mobile device. The response includes the requested customized information regarding the product or service. The customized response, including information associated with the current location of the mobile device, is provided to the mobile device.

According to another embodiment, a device provides customized information to at least one mobile device with respect to at least one provider of products or services. The device includes an input for receiving, from at least one mobile device, at least one request for customized information regarding a product or service from the at least one provider of products or services. The device further includes a memory for storing at least one business rule and a processor in communication with the memory for generating a customized response to the request based on application of the at least one business rule and a current location of the mobile device. The response includes the requested customized information regarding the product or service. The device further includes an output for providing, to the mobile device, the customized response including information associated with the current location of the mobile device.

According to another embodiments, a non-transitory computer program product includes a storage medium upon which instructions are recorded that, when executed by a processor perform a method for providing customized information to at least one mobile device with respect to at least one provider of products or services. The method includes receiving, from at least one mobile device, at least one request for customized information regarding a product or service from the at least one provider of products or services. The method further includes generating a customized response to the request based on application of a business rule and a current location of the mobile device. The response includes the requested customized information regarding the product or service. The method further includes providing, to the mobile device, the customized response including information associated with the current location of the mobile device.

### BRIEF DESCRIPTION OF THE DRAWINGS

FIG. 1 illustrates an exemplary environment in which customized information may be provided to one or more mobile devices according to an exemplary embodiment.

FIG. 2 illustrates a block diagram of a device for providing customized information to one or more mobile devices according to an exemplary embodiment.

FIGS. 3 and 4 illustrate how customized information may be provided to a user of a mobile device according to an exemplary embodiment.

FIG. 5 is a flow chart illustrating a method for providing customized information to a mobile device according to an exemplary embodiment.

### DETAILED DESCRIPTION

Detailed exemplary embodiments are disclosed herein. It must be understood that the embodiments described and illustrated are merely examples that may be embodied in various and alternative forms, and combinations thereof. As used herein, the word “exemplary” is used expansively to refer to embodiments that serve as examples or illustrations. The figures are not necessarily to scale and some features may be exaggerated or minimized to show details of particular components. Specific structural and functional details disclosed herein are not to be interpreted as limiting.

Current information provided by GPS systems is limited and cannot be customized based on information from a provider of products or services. Thus, providers of products and/or services are at the mercy of the accuracy of the GPS map database. This presents a problem, e.g., if the address of a store changes, a new store opens, or a store closes. There is currently no capacity for the GPS system to allow an interface between a provider of products and/or services and mobile device users. Thus, for example, a user of a GPS system may find that there are twenty restaurants located nearby but is unable to obtain from the GPS application information regarding which restaurant is open and closest or more detailed information, such as customer reviews, whether the restaurant is family friendly, has a dress code, was a waiting list for seating, has special promotions, etc.

According to exemplary embodiments, customized information is provided to one or more mobile devices regarding providers of products and/or services based in part on a current location of the mobile device(s). According to one embodiment, providers of products and/or services having websites can have a location icon on their websites, described in further detail below. The location icon may be implemented using any suitable web page or markup language, e.g., HTML, XML, and any suitable protocol, e.g., HTTP, may be used in conjunction with the location icon to communicate requests and responses, including but not limited to HTML, XML or other suitable protocols. The providers of products and/or services can dynamically customize content provided to a user of a mobile device, based on a request from the user and based on a current location of the mobile device. To initiate a request for information, a user may connect to the provider's home website, input the request for information, and click on the location icon, directing the user to a link. The link provides customized information responsive to the user's request. The information may contain, e.g., an address of the closest provider having a requested product or service available, hours of operation, etc. Further examples of customized information are provided below

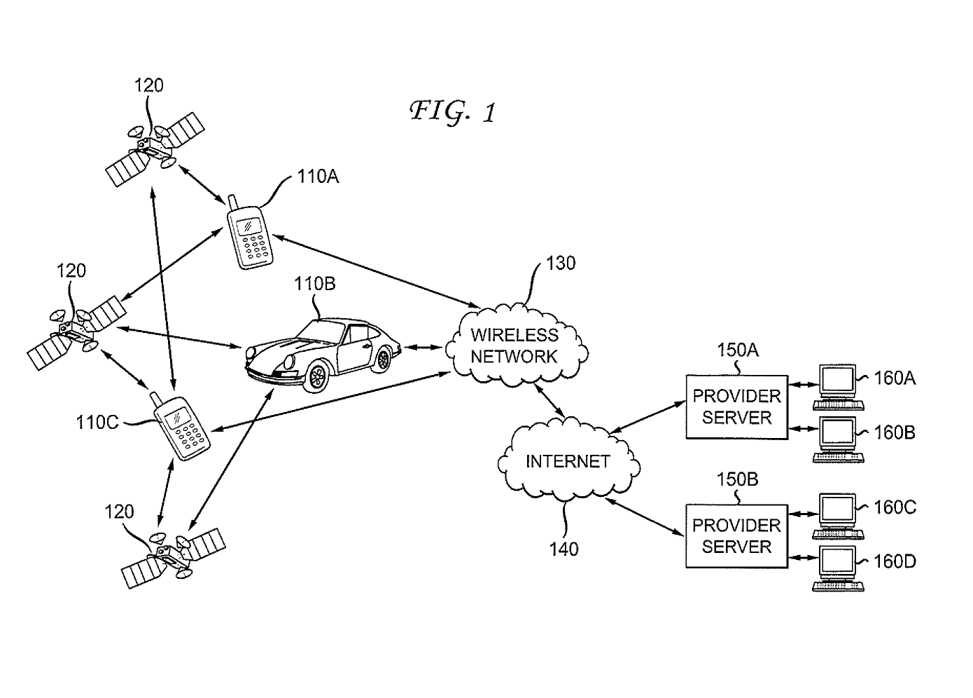

FIG. 1 illustrates an exemplary environment in which customized information may be provided to a mobile device. Referring to FIG. 1, GPS-enabled mobile devices 110A, 110B, and 110C are in communication with GPS satellites 120 which track the location of the mobile devices. Although not shown for simplicity of illustration, these satellites 120 are also in communication with other components of a GPS system, as those skilled in the art will appreciate. The location information may be provided directly to the mobile devices 110A, 110B, and 110C. This location information, in turn, may be transmitted via one or more networks, e.g., a wireless network 130 and the Internet 140, to Provider Servers 150A and 150B. As an alternative, the location information may be provided to a location server (not shown) and then delivered to the Provider Servers 150A and 150B. The Provider Servers 150A and 150B are, in turn, in communication with individual provider locations 160A and 160B and provider locations 160C and 160D, respectively. For illustrative purposes, the provider locations 160A, 160B, 160C, and 160D are represented as desktop computers, but it should be appreciated that any suitable communication device may be implemented at the provider locations 160A, 160B, 160C, and 160D. Although shown as separate devices, the Provider Servers 150A and 150B may be collocated with the provider locations 160A and 160B and the provider locations 160C and 160D, respectively. Further, although three mobile devices, two provider servers, and four provider locations are shown for simplicity of illustration, it should be appreciated that embodiments described herein may be applicable to any number of mobile devices, provider servers, and provider locations. Also it should be appreciated that the mobile devices 110A, 110B, and 110C may communicate with the Provider Servers 150A, and 150B via any suitable network(s).

In addition to receiving location information regarding the mobile devices 110A, 110B, and 110C, the Provider Servers 150A and 150B receive requests for customized information regarding products and/or services from one or more of the mobile devices 110A, 110B, and 110C. For example, a user of a mobile device 110A may log onto a website of a Provider Server 150 which serves a chain of restaurants. The user may log on via, e.g., the Wireless Network 130 and the Internet 140, and input a request for a reservation at a particular time as well as information regarding a dress code, and click on the location icon on the webpage. The Provider Server 150A communicates with various provider locations 160A and 160B (which are, in this example, restaurants), to determine whether reservations are available and which location is closest to the current location of the mobile device 110A. The Provider Server 150A may then generate a customized response, including which locations have reservations available at what times, information regarding the dress code, and information indicating which restaurant is closest to the current location of the mobile device 110A. The Provider Server 150A may also provide directions and/or a map to one or more of the restaurants.

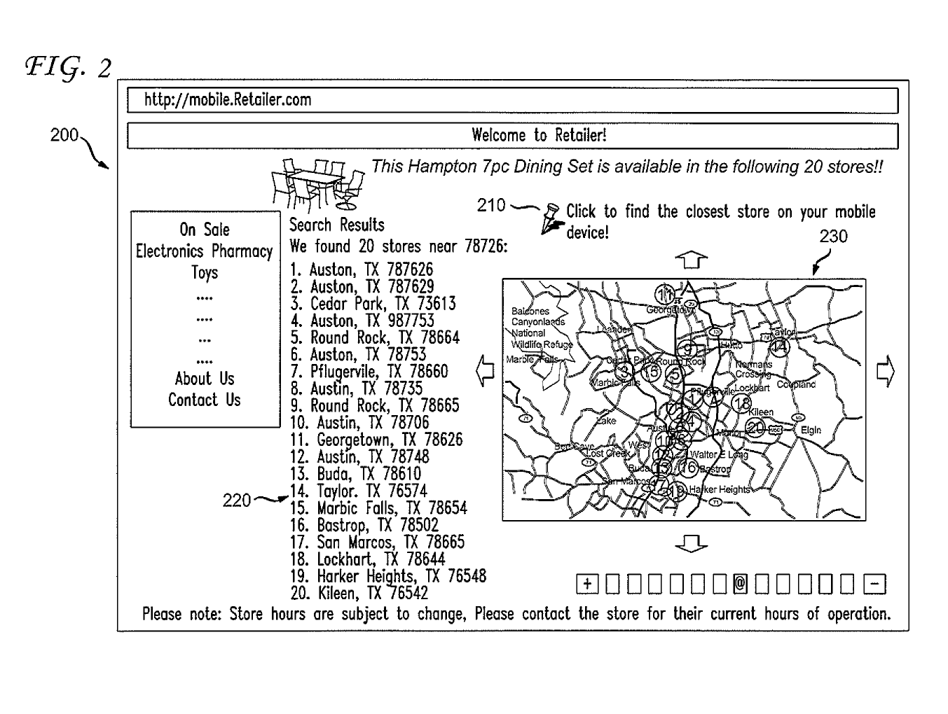

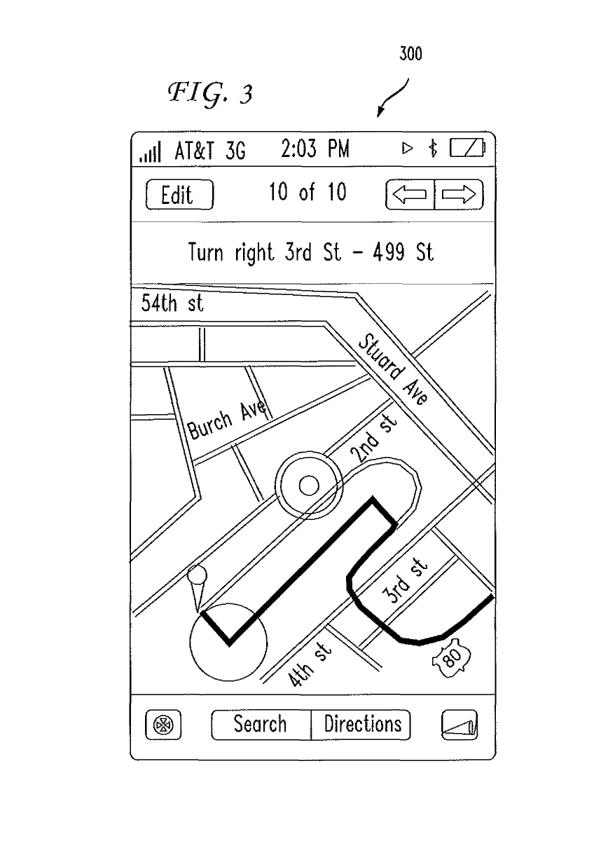

To better understand how customized information is provided to a mobile device, consider the illustrative example shown in FIGS. 2 and 3. In this example, a user of a mobile device who is interested in purchasing a seven-piece dining set has connected to a provider's website 200. In this particular example, the provider is a chain retailer. The user has input a request for the dining set, which has been received by a provider server serving the chain retailer. The provider server generates a response based, e.g., on a database reflecting the inventory for each of the provider locations, which are, in this example, store locations. This inventory may be updated periodically or in real time upon communication with the provider locations. As shown in FIG. 2, the website 200 indicates that the dining set is available at 20 stores, listing the stores as search results 220. The list of store may be filtered, e.g., by applying business rules to reduce the number of stores listed based on location or other criteria. For example, stores that are the furthest away from the current location mobile device may be filtered out of the listing. The website 200 may also indicate, responsive to a user request, store hours of each location, which stores have discounts/incentives, the variety of dining sets available, the number of dining sets available at each store, etc. The locations of the stores may also be presented on a map 230. The website 200 may dynamically create a location icon 210 that the user may click on to determine the store that is closest to a current location of the mobile device and that meets certain criteria of the user, e.g., the store that is closest and that is open the latest. A user of the mobile device may reserve the requested dining set so that it is available for pick up when the user arrives at the store.

Upon selection of a particular store that meets the user's criteria and that is closest to a current location of the mobile device, a map to the user may be presented via the GPS application of the mobile device. An example of such a map is shown in FIG. 3. The map 300 shows the route from the current location of the mobile device to the store that meets the user's criteria.

FIG. 4 is a block diagram of a device for providing customized user information according to one embodiment. The device 400 may be implemented at each of the Provider Servers 150A and 150B. The device 400 includes a processor 410 that receives information, such as requests from mobile devices 110A, 110B, and 110C, via I/O Data Ports 420. The I/O Data Ports 420 can be implemented with, e.g., an interface including an antenna or other suitable type of transceiver through which data and signals may be transmitted and received. It should be appreciated that the I/O Data Ports 420 can be used for communications between the mobile devices 110A, 110B, 110C via the networks 130 and 140, as well as for communications between the Provider Locations 160A, 160B, 160C, and 160D and other providers of data that may be relevant to providing customized responses, e.g., traffic sensors, etc. Thus, in addition to any data that may be stored in the database 450 in the memory 430, the processor 410 may also receive other information that may be relevant to a request from a user, e.g., traffic data, inventory imputs from Provider Locations 160A, 160B, 160C, 160D, etc.

The processor 410 communicates with the memory 430 via, e.g., an address/data bus. The processor 410 can be any commercially available or customer microprocessor. The memory is 430 is representative of the overall hierarchy of memory devices containing the software and data used to implement the functionality of the device 400. The memory 430 can include but is not limited to the following types of devices: processor registers, processor cache, RAM, ROM, PROM, EPROM, EEPROM, flash memory, SRAMD, DRAM other volatile memory forms, and non-volatile, semi-permanent or permanent memory types; for example, tape-based media, optical media, solid state media, hard disks, combinations thereof, and the like.

As shown in FIG. 4, the memory 430 may include several categories of software and data used in the device 400, including, applications 440, a database 450, an operating system (OS) 460, and the input/output (I/O) device drivers 470. As will be appreciated by those skilled in the art, the OS 460 may be any operating system for use with a data processing system. The I/O device drivers 470 may include various routines accessed through the OS 460 by the applications 440 to communicate with devices, and certain memory components. The applications 440 can be stored in the memory 430 and/or in a firmware (not shown) as executable instructions, and can be executed by the processor 410. The applications 440 include various programs that implement the various features of the device 400, including a business rules application that contains predefined business rules to apply to data stored in the database 450, along with data received via the I/O data ports 420 to generate customized responses to user requests by the processor 410. The database 450 represents the static and dynamic data used by the applications 440, the OS 460, the I/O device drivers 470 and other software programs that may reside in the memory. The database 450 may include, for example, stored information regarding inventory/availability of products and/or services as well as information regarding store hours, store policies, etc.

While the memory 430 is illustrated as residing proximate the processor 410, it should be understood that at least a portion of the memory 430 can be a remotely accessed storage system, for example, a server on a communication network, a remote hard disk drive, a removable storage medium, combinations thereof, and the like. Thus, any of the data, applications, and/or software described above can be stored within the memory 430 and/or accessed via network connections to other data processing systems (not shown) that may include a local area network (LAN), a metropolitan area network (MAN), or a wide area network (WAN), for example.

It should be understood that FIG. 4 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

Although the embodiments describes above related to GPS-enabled mobile devices, it should be appreciated that the location information of the mobile devices 110A, 110B, and 110C may be obtained and communicated using any appropriate location system, e.g., a location server receiving A-GPS data, data transmitted via WIFI®, or data transmitted via WIMAX®. The location server can receive and/or transmit signals via one or more antennae. The location component server can interface with components of a location network, such as a GPS network or a radio network. Other alternatives for location-tracking may include cellular network triangulation signaling, short range beacon signaling, and/or combinations thereof, and the like, These alternatives may be useful when GPS service is unavailable, e.g., indoors, or if a mobile device is not GPS-enabled. In such cases, signals from cell sites serving a mobile device may be used to determine a current location of a mobile device.

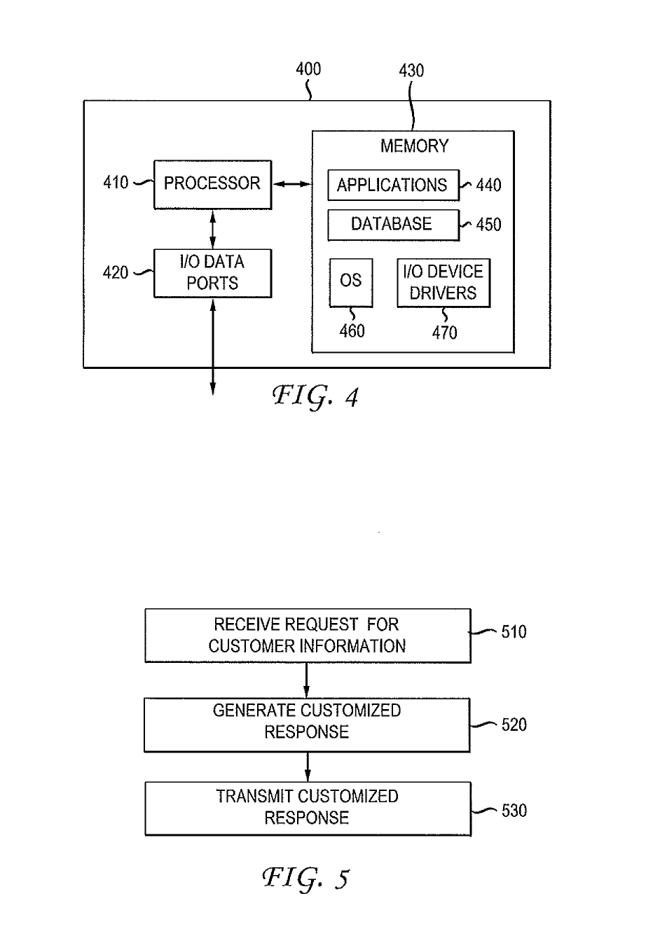

FIG. 5 is a flow chart illustrating a process for providing customized information to a mobile device according to one embodiment. At step 510, a request is received from a mobile device, e.g., one or more of the mobile devices 110A, 110B, and 110C, for customized information regarding a product and/or service from a provider of products and/or services. The request may be receive at a provider location, e.g., Provider Locations 160A, 160B, 160C, or 160D, or at a provider server in communication with one or more provider locations, e.g., Provider Servers 150A and 150B. For example, for a provider that is a chain retailer, the request may be received at a provider server serving various provider locations. For a provider with a single location, the request may be received at the provider location. At step 520, a customized response to the request is generated based on application of a business rule and a current location of the mobile device. The business rule may include, for example, determining availability of the requested product or service, determining hours of operation of a provider, etc., depending on the request. The customized response includes the requested customized information regarding the product or service, including information related to a current location of the mobile device. At step 530, the customized response including information associated with the current location of the mobile device is transmitted to the mobile device.

Although the examples above relate to providers of products and services, such as restaurants and chain retailers, it should be appreciated that customized information may be provided to a mobile device regarding any provider of products and/or services. For example, the embodiments above may be used to reserve a particular parking space via contact with a parking company by a mobile device, reserve a ticket for an entertainment event via contact with an entertainment company, etc. In such instances in which products or services are reserved, the user may be provided with a code or other data with which to redeem the reserved item as part of the customized response.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A method for providing customized information to at least one mobile device with respect to at least one provider of products or services, comprising:
receiving, from at least one mobile device, at least one request for customized information regarding a product or service from the at least one provider of products or services;
generating a customized response to the request based on application of a business rule and a current location of the mobile device, wherein the customized response includes the requested customized information regarding the product or service;
transmitting, to the mobile device, the customized response including information associated with the current location of the mobile device.

2. The method of claim 1, further comprising determining, from among a plurality of locations of the at least one provider of products or services, a location that is most easily accessible with respect to the current location of the mobile device and that is able to satisfy the request.

3. The method of claim 1, wherein generating the customized response includes determining availability of the product or service at one or more locations of the at least one provider of products or services within a particular distance from the current location of the mobile device.

4. The method of claim 2, wherein determining the location that is most easily accessible takes into account at least one of distance between the one or more locations of the at least one provider of products or services from the current location of the mobile device, hours or operation of the one or more locations of the at least one provider of products or services, and current traffic conditions.

5. The method of claim 4, wherein the customized information provided to the mobile device indicates the location of the at least one provider of products or services that is most easily accessible with respect to the mobile device and includes directions to the most easily accessible location of the at least one provider of products or services.

6. The method of claim 1, further comprising reserving, responsive to a request from the mobile device, the product or service at one or more locations of the at least one provider of products or services having the at least one product or service available and providing the mobile device with information for redeeming the reserved product or service at one or more locations of the at least one provider of products or services

7. The method of claim 1, further comprising providing, to the mobile device, information regarding at least one of pricing, discounts and incentives related to the product or service available at one or more locations of the at least one provider of products or services.

8. A device for providing customized information to at least one mobile device with respect to at least one provider of products or services, comprising:
an input for receiving, from at least one mobile device, at least one request for customized information regarding a product or service from the at least one provider of products or services;
a memory for storing at least one business rule;
a processor in communication with the memory for generating a customized response to the request based on application of the at least one business rule retrieved from the memory and a current location of the mobile device, wherein the response includes the requested customized information regarding the product or service; and
an output for providing, to the mobile device, the customized response including information associated with the current location of the mobile device.

9. The device claim 8, wherein the processor determines, from among a plurality of locations of the at least one provider of products or services, a location that is most easily accessible with respect to the current location of the mobile device and that is able to satisfy the request.

10. The device of claim 8, wherein the processor generates the customized response by determining availability of the product or service at one or more locations of the at least one provider of products or services within a particular distance from the current location of the mobile device.

11. The device of claim 9, wherein in determining the location that is most easily accessible, the processor takes into account at least one of distance between the one or more locations of the at least one provider of products or services from the current location of the mobile device, hours or operation of the one or more locations of the at least one provider of products or services, and current traffic conditions.

12. The device of claim 10, wherein the customized information provided to the mobile device indicates the location of the at least one provider of products or services that is most easily accessible with respect to the mobile device and includes directions to the most easily accessible location of the at least one provider of products or services.

13. The device of claim 8, wherein the output providers, to the mobile device, information regarding at least one of pricing, discounts and incentives related to the product or service available at one or more locations of the at least one provider of products or services.

14. A non-transitory computer program product including a storage medium upon which instructions are recorded that, when executed by a processor perform a method for providing customized information to at least one mobile device with respect to at least one provider of products or services, comprising:
receiving, from at least one mobile device, at least one request for customized information regarding a product or service from the at least one provider of products or services;
generating a customized response to the request based on application of a business rule and a current location of the mobile device, wherein the response includes the requested customized information regarding the product or service;
providing, to the mobile device, the customized response including information associated with the current location of the mobile device.

15. The non-transitory computer program product method of claim 14, wherein the instructions further cause the processor to determine, from among a plurality of locations of the at least one provider of products or services, a location that is most easily accessible with respect to the current location of the mobile device and that is able to satisfy the request.

16. The non-transitory computer program product of claim 14, wherein generating the customized response includes determining availability of the product or service at one or more locations of the at least one provider of products or services within a particular distance from the current location of the mobile device.

17. The non-transitory computer program product of claim 15, wherein determining the location that is most easily accessible takes into account at least one of distance between the one or more locations of the at least one provider of products or services from the current location of the mobile device, hours or operation of the one or more locations of the at least one provider of products or services, and current traffic conditions.

18. The non-transitory computer program product of claim 17, wherein the customized information provided to the mobile device indicates the location of the at least one provider of products or services that is most easily accessible with respect to the mobile device and includes directions to the most easily accessible location of the at least one provider of products or services.

19. The non-transitory compute reprogram product of claim 14, wherein, responsive to a request from the mobile device, the product or service at one or more locations of the at least one provider of products or services having the at least one product or service available is reserved, and the mobile device is provided with information for redeeming the reserved product or service at one or more locations of the at least one provider of products or services.

20. The non-transistor computer program product of claim 14, wherein the processor provides, to the mobile device, information regarding at least one of pricing, discounts and incentives related to the product or service available at one or more locations of the at least one provider of products or services.
